(19) United States
(12) Patent Application Publication
(10) Pub. No.: US 2013/0147841 A1
(43) Pub. Date: Jun. 13, 2013

(54) INTERACTIVE NAVIGATION AND VIEW SELECTION IN DIGITAL CARTOGRAPHY

(71) Applicants: Didier Coussemaeker, Seattle, WA (US); Jagannatha Raju Dantuluri, Sammamish, WA (US)

(72) Inventors: Didier Coussemaeker, Seattle, WA (US); Jagannatha Raju Dantuluri, Sammamish, WA (US)

(73) Assignee: Microsoft Corporation, Redmond, WA (US)

(21) Appl. No.: 13/314,202

(22) Filed: Dec. 8, 2011

(51) Int. Cl. G09G 5/00

(52) U.S. Cl. 345/634

(57) ABSTRACT

Architecture that enables interactive navigation and view selection in digital cartography. Multiple mapping views (or zoom levels) can be presented concurrently in a map area of the display. The mapping views are located and presented in relation to a fixed position of the display for interactive selection (e.g., on touch screens). A center area of the map area includes a primary view for presentation of a portion of a map, and one or more secondary areas (on the periphery of the center area) that present one or multiple secondary views. Note that the primary and secondary views differentiate the amount of map details presented. For example, the primary view can show more detailed cartographic data while the secondary view(s) show less detail, but a greater amount of cartographic data for the geographical region surrounding the primary view.

### BACKGROUND

Cartography systems offer multiple views to represent the same geographical area such as in multiple zoom levels and multiple mapping types (e.g., road view with or without traffic, aerial view, terrain view, bird's eye view, street view, etc.). The usual way to switch between zoom levels and mapping modes is to use standard user interface elements such as buttons, overlay icons, or menu items. These elements typically require more localization than the map and the vocabulary can be ambiguous (e.g., aerial versus satellite), whereas the concepts are easier to understand visually with an example.

Switching between zoom levels and modes is generally fully modal and updates the whole map. There is a common way to display two zoom levels or two modes together by placing a smaller map in the corner of a larger map, but with this solution the same geographical location is represented by two different points in the smaller and in the larger maps, which can be unclear.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture enables interactive navigation and view selection in digital cartography. The architecture enables the display of multiple mapping views (or zoom levels) concurrently in a map area of the display. The mapping views are located and presented in relation to a fixed position of the display for interactive selection (e.g., on touch screens).

A center area (or inner area) of the map area includes a primary view (or zoom level) for presentation of a portion of a map, and one or more secondary areas (on the periphery of the center area) that present one or multiple secondary views (or zoom levels). Note that the zoom levels between the primary and secondary views differentiate the amount of map details presented. For example, the primary view can show more detailed cartographic data while the secondary view(s) show less detail, but a greater amount of cartographic data for the geographical region surrounding the primary view. All the views (maps) are positioned in the map area related to the fixed position.

Selecting an alternative mode (e.g., by touching) in a secondary area will switch, temporarily or permanently, the center area to the selected secondary area. Changing the current state in the primary area (e.g., panning the map or changing the current zoom level) triggers an equivalent change in all the secondary areas currently displayed.

In other words, visual selection and self-discovery is enabled such that when the user views a real example of the alternative mode(s) in the geographical area of interest, the user can bring into view and greater detail a geographic area by selecting (e.g., touch) the desired secondary view to display the secondary view as the primary view.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with the disclosed architecture.

FIG. 2 illustrates an exemplary multi-view navigation user interface.

FIG. 3 illustrates an alternative exemplary multi-view navigation user interface.

FIG. 4 illustrates an alternative exemplary multi-view navigation user interface having three secondary views.

FIG. 5 illustrates an alternative exemplary multi-view navigation user interface having four secondary views.

FIG. 6 illustrates a rendering of an exemplary multi-view navigation user interface.

FIG. 7 illustrates a method in accordance with the disclosed architecture.

FIG. 8 illustrates further aspects of the method of FIG. 7.

FIG. 9 illustrates an alternative method in accordance with the disclosed architecture.

FIG. 10 illustrates further aspects of the method of FIG. 9.

FIG. 11 illustrates a block diagram of a computing system that executes interactive navigation and view selection in digital cartography in accordance with the disclosed architecture.

### DETAILED DESCRIPTION

The disclosed architecture enables interactive navigation and view selection in digital cartography. The architecture enables the display of multiple mapping views (or zoom levels) concurrently in a map area of the display, the mapping views in relation to a fixed position of the display for interactive selection (e.g., on touch screens). A center area (or inner area) of the map area includes a primary view (or zoom level) for presentation a portion of a map, and one or more secondary areas (on the periphery of the center area) that present one or multiple secondary views (or zoom levels). Note that the zoom levels between the primary and secondary views differentiate the amount of map details presented. For example, the primary view can show more detailed cartographic data while the secondary view(s) show less detail, but a greater amount of cartographic data for the geographical region surrounding the primary view. All the views (maps) are positioned in the map area related to the fixed position.

Selecting a secondary view in the periphery switches, temporarily or permanently, the center area (primary view) to the selected secondary view. Changing the current state in the primary view (e.g., panning the map or changing the current zoom level) triggers an equivalent change in all the secondary views currently displayed. The architecture also works on both offline and online maps.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

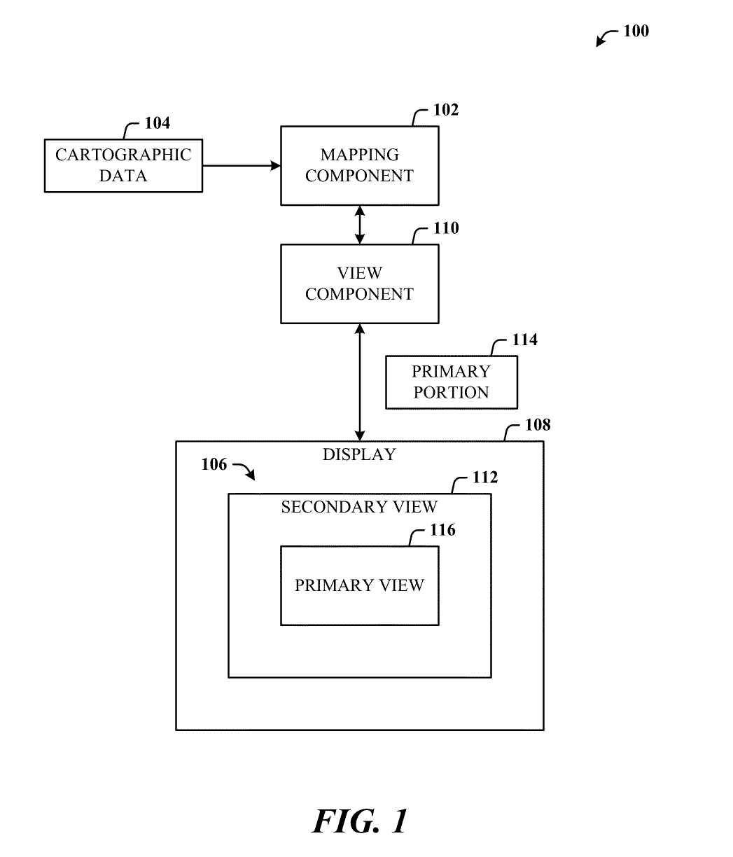

FIG. 1 illustrates a system 100 in accordance with the disclosed architecture. The system 100 includes a mapping component 102 that receives cartographic data 104 such as maps, vector maps, and map tiles (e.g., from a mapping tile service) for viewing in multiple views in a map display area 106 on a display 108. A view component 110 presents the cartographic data 104 in an interactive secondary view 112 and a primary portion 114 of the cartographic data 104 in an interactive primary view 116. The primary and secondary views (112 and 116) are positioned or located relative to a fixed position in the map display area 106.

The locations of the primary view 116 and the secondary view 112 are maintained (e.g., programmatically) in location relative to the fixed position in the map display area 106 of the display 108. The location of the fixed position and the location of the primary view 116 and the secondary view 112 relative to the fixed position, are constantly maintained relative to the fixed position. This also means relative to the borders (e.g., the center) of the map display area 106 of the display 108 during updates in the cartographic data 104 in response to interactive changes in the cartographic data 104 as viewed. In other words, in general, the views (112 and 116) will occupy only a portion of the physical display—not all of the display, although this is possible. For example, if the standard layout on a particular mobile operating system has reserved areas (unavailable for display of the views) at the top part of the display for a status bar and the bottom part of the display for a menu bar, these reserved areas are not available to the map. Additionally, while the point-of-interest of the map is generally the center of the polygon (e.g., rectangular map display area 106) occupied by the views (112 and 116), the point-of-interest can potentially be any fixed position (e.g., relative to the borders of the available display space). The primary view 116 can be temporarily hidden in response to interaction with the secondary view 112. The secondary view 112 consumes the available space of the display 108 or in another results, the map display area 106 of the display 108 (e.g., entirely) in response to interaction with the secondary view 112.

The primary view 116 is an enlarged view (zoom in) of a portion of the cartographic data 104 of the secondary view 112. The interaction with a given portion of the cartographic data 104 in the secondary view 112 promotes the given portion of the cartographic data 104 to the primary view 116. The view component 110 changes the cartographic data 104 in the primary view 116 in response to an interactive change in the cartographic data 104 in the secondary view 112. The view component 110 changes the cartographic data 104 in the secondary view 112 in response to an interactive change in the cartographic data in the primary view 116.

Different zoom levels enable fast map panning The primary view 116 is a map using a specific zoom level. The secondary view 112 uses the same map type, but with a lower zoom level (e.g., less detailed and representing a larger geographical area). When the user interacts (e.g., makes a swipe touch gesture) to pan the map in the primary view, the center of the secondary view map is updated to follow the movement over the map in the primary view 116.

When using a touch interaction, for example, when the user touches the secondary view 112 area, the map of the primary view 116 can be hidden temporarily and the full map area or the full display area of the display 108 can be used by the secondary view 112 map. The user can easily and quickly move the map of the secondary view 112 such that a different or distant location is viewed, based on the lower zoom level of the secondary view 112. When the user delays interaction with the map of the secondary view 112 for a predetermined amount of time (e.g., two seconds), a timeout occurs and the primary view 116 map is re-displayed, using the different or distant location selected via the secondary view 112 map as the fixed position point.

Alternative mapping views are illustrated and described hereinbelow that can use the same map type and different zoom levels, different map types and the same zoom level, and/or different map types and different zoom levels.

Selecting a secondary view can be triggered by different interactions depending on the hardware (e.g., device such as a handheld mobile device) and the general look and feel of the device. In other words, the interactions include, but are not limited to, a single tap, multiple taps, or touch gesture on a touch screen, keyboard input, buttons, mouse, light pens, device position or orientation change (e.g., via an accelerometer), or other input mechanisms that are available on the platform. In a more robust implementation, it is within contemplation of the disclosed architecture that voice control can be utilized to interact with the primary and secondary views.

Changing (e.g., a move operation) the fixed position (the geographic location on a map) for the primary view 116 (e.g., by panning the map) results in replication of the move in all displayed secondary views. If the secondary views were extended to the whole screen, the fixed position then represents the same geographical location. Other parameters such as the zoom level may or may not be updated in the secondary view 112 when the change is made in the primary view 116. The zoom level update can be made implementation dependent, as desired.

Selecting a secondary view may cause swapping of the primary and secondary views: in other words, the secondary view 112 becomes the new primary view and the existing primary view becomes a secondary view displayed in the same way as the selected secondary view. Selecting a secondary view may allocate the whole screen to the secondary view mode temporarily or permanently. The architecture can provide the user with a mechanism to return to the multiple views.

In order to optimize performance, a view can use a simplified representation when used only as secondary view. The simplified representation is visually similar to the full representation to assist the user in immediately identifying the view and the view is an actual map of the correct location (in contrast to an example or a static image).

The separation between the primary view and each secondary view, and the separation between the different secondary views can be displayed as a sharp limit (demarcation), with or without a border line to make the separation more noticeable to the user. Alternatively, or in combination therewith, the separation can be displayed as a progressive transition using fading, alpha-blending, or other similar visual effects, for example.

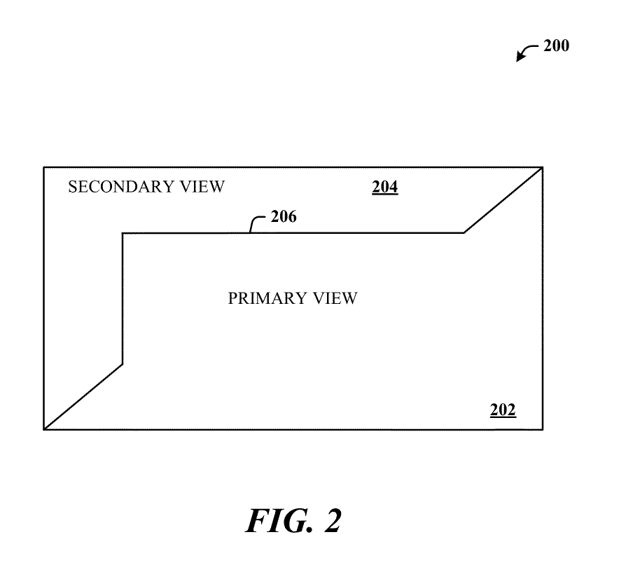

FIG. 2 illustrates an exemplary multi-view navigation user interface 200. The interface 200 includes a primary view 202 (similar to primary view 116) and a secondary view 204 (similar to secondary view 112). The secondary view 204 is positioned above and along the left side of the primary view 202. The interface 200 employs a diagonal separator 206 that provides a visually perceptible separation to a viewer.

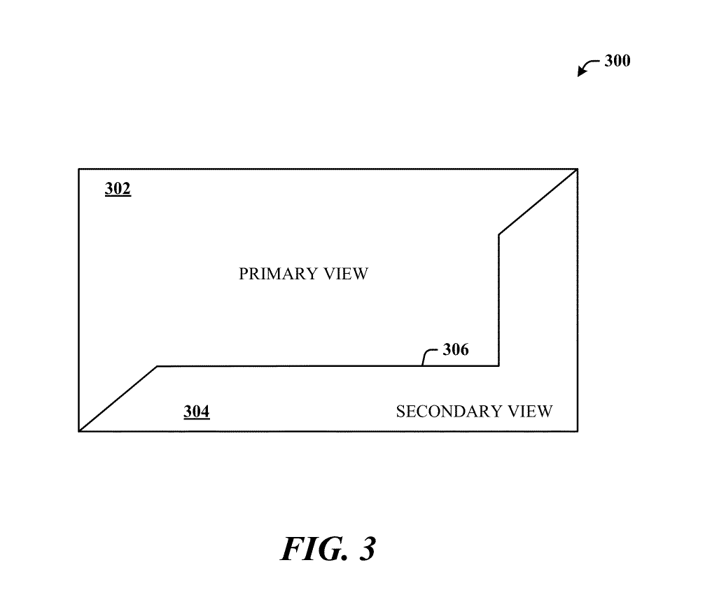

FIG. 3 illustrates an alternative exemplary multi-view navigation user interface 300. The interface 300 includes a primary view 302 (similar to primary view 116) and a secondary view 304 (similar to secondary view 112). In this implementation, the secondary view 304 is positioned below and along the right side of the primary view 302. The interface 300 employs a diagonal separator 306 that provides a visually perceptible separation between the primary view 302 and the secondary view 304 to a viewer.

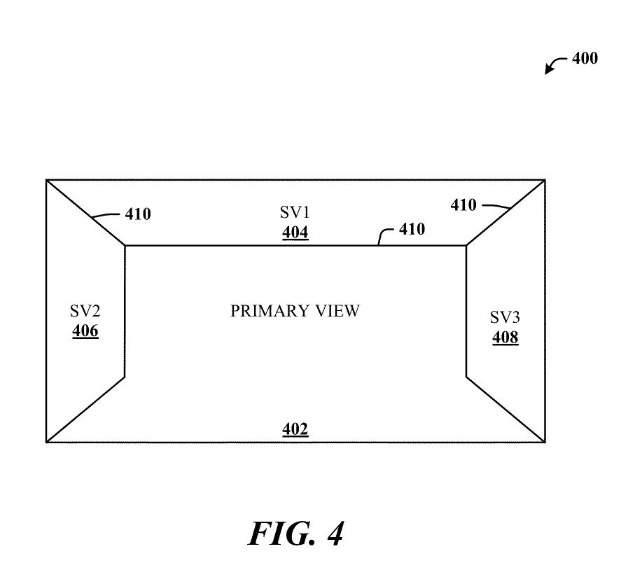

FIG. 4 illustrates an alternative exemplary multi-view navigation user interface 400 having three secondary views. The interface 400 includes a primary view 402 (similar to primary view 116) and multiple secondary views (each similar to secondary view 112): a secondary view (SV1) 404, a secondary view (SV2) 406, and a secondary view (SV3) 408. In this implementation, the secondary view (SV1) 404 is generated above the primary view 402, the secondary view (SV2) 406 is generated left of the primary view 402, and the secondary view (SV3) 408 is generated right of the primary view 402. The interface 400 employs separators 410 that provide visually perceptible separation between the primary view 402 and the secondary views (404, 406, and 408) to a viewer.

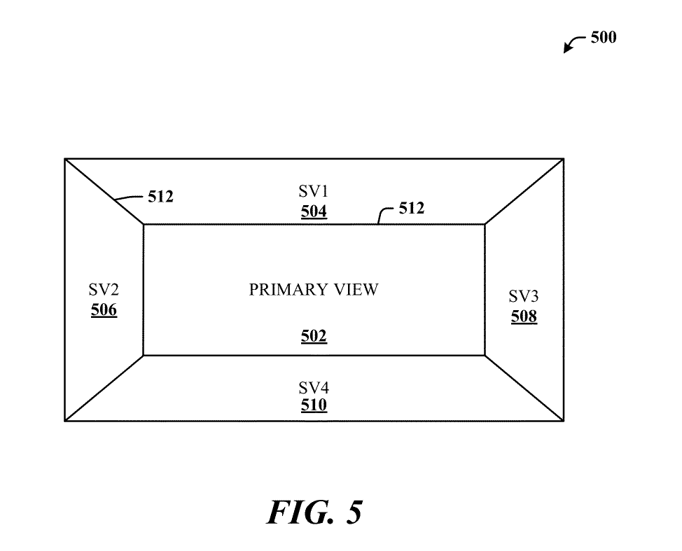

FIG. 5 illustrates an alternative exemplary multi-view navigation user interface 500 having four secondary views. The interface 500 includes a primary view 502 (similar to primary view 116) and multiple secondary views (each similar to secondary view 112): a secondary view (SV1) 504, a secondary view (SV2) 506, a secondary view (SV3) 508, and a secondary view (SV4) 510. In this implementation, the secondary view (SV1) 504 is generated above the primary view 502, the secondary view (SV2) 506 is generated left of the primary view 502, the secondary view (SV3) 508 is generated right of the primary view 502, and the secondary view (SV3) 510 is generated below the primary view 502. The interface 500 employs separators 512 that provide visually perceptible separation between the primary view 502 and the secondary views (504, 506, 508, and 510) to a viewer.

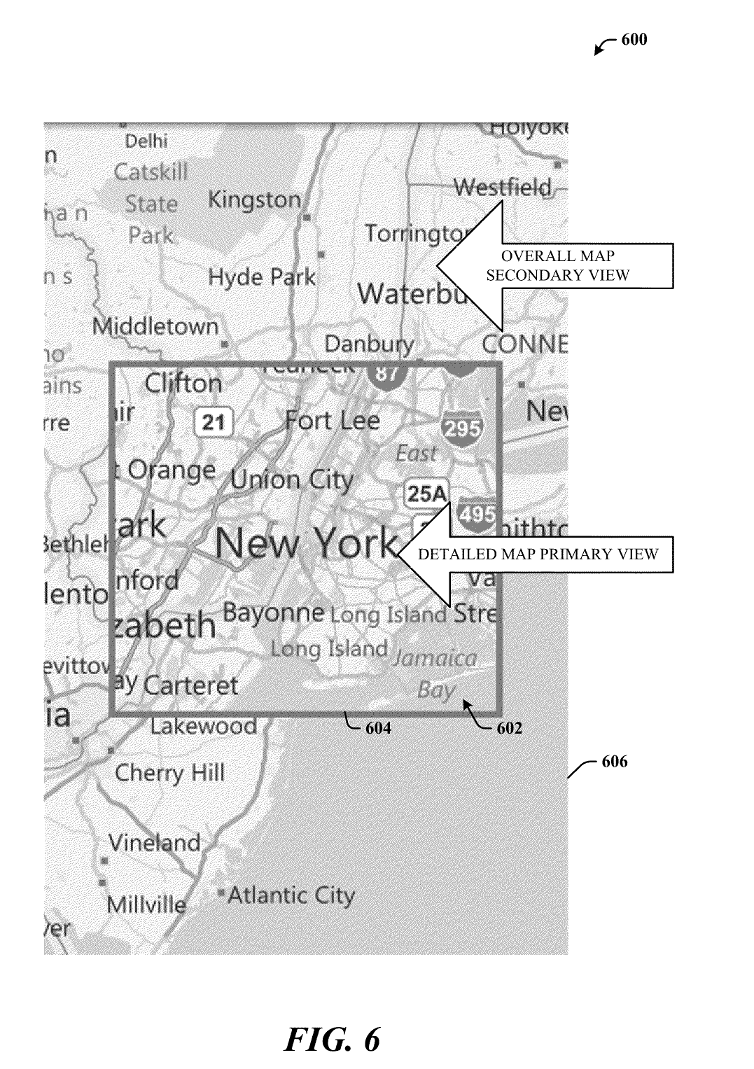

FIG. 6 illustrates a rendering of an exemplary multi-view navigation user interface 600 for New York City. The interface 600 includes a primary view 602 circumscribed by a visually perceptible separator 604 that separates the primary view 602 from a secondary view 606. The secondary view 606 is an overall map in the surrounding area of New York City. The secondary view 606 has less detail than the primary view 602 at least in terms of roads and other terrestrial constructs (e.g., rivers, railroad tracks, bodies of water, cities, etc.).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

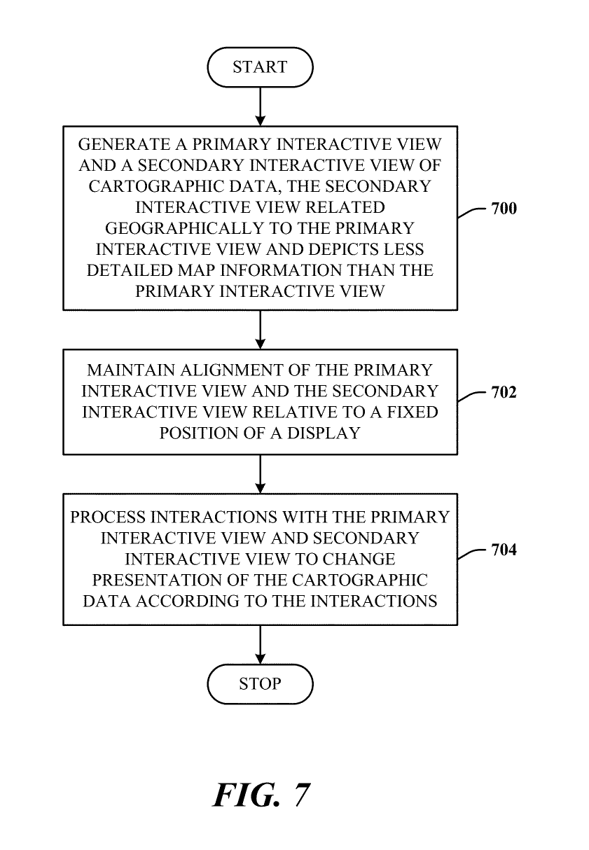

FIG. 7 illustrates a method in accordance with the disclosed architecture. At 700, a primary interactive view and a secondary interactive view of cartographic data are generated. The secondary interactive view is related geographically to the primary interactive view and depicts less detailed map information than the primary interactive view. At 702, alignment of the primary interactive view and the secondary interactive view is maintained relative to a fixed position in a display. At 704, interactions with the primary interactive view and secondary interactive view are processed to change presentation of the cartographic data according to the interactions.

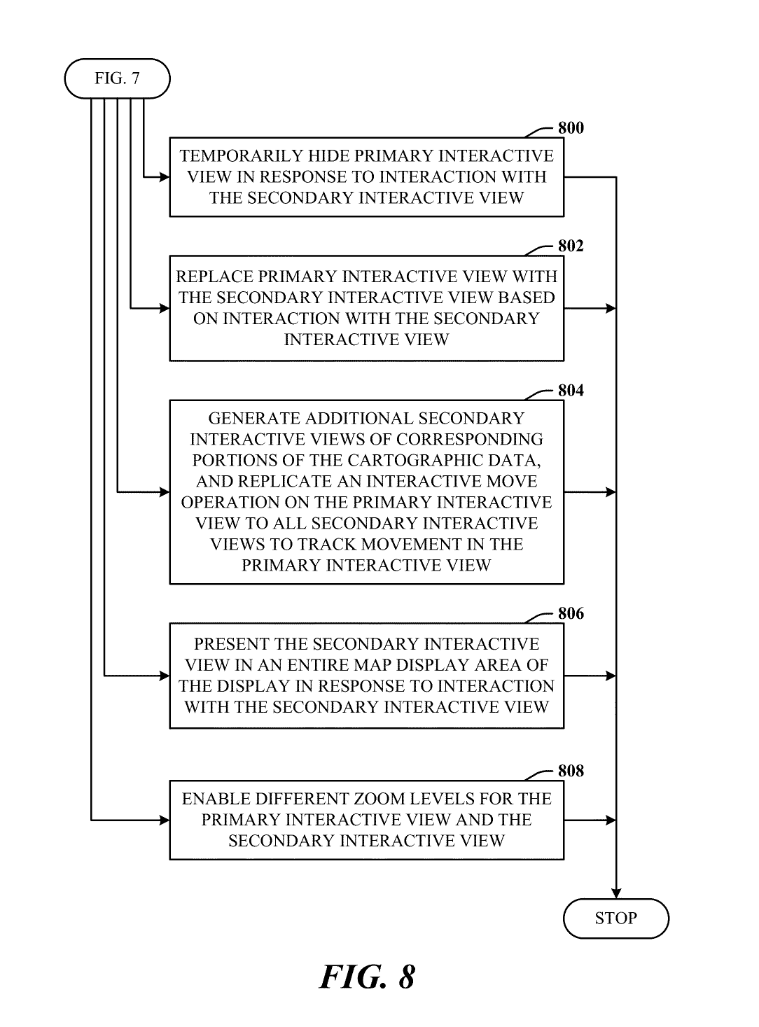

FIG. 8 illustrates further aspects of the method of FIG. 7. Note that the flow indicates that each block can represent a step that can be included, separately or in combination with other blocks, as additional aspects of the method represented by the flow chart of FIG. 7. At 800, the primary interactive view is temporarily hidden in response to interaction with the secondary interactive view. At 802, the primary interactive view is replaced with the secondary interactive view based on interaction with the secondary interactive view. At 804, additional secondary interactive views of corresponding portions of the cartographic data are generated, and an interactive move operation is replicated on the primary interactive view to all secondary interactive views to track movement in the primary interactive view.

At 806, the secondary interactive view is presented in an entire map display area of the display in response to interaction with the secondary interactive view. At 808, different zoom levels are enabled for the primary interactive view and the secondary interactive view.

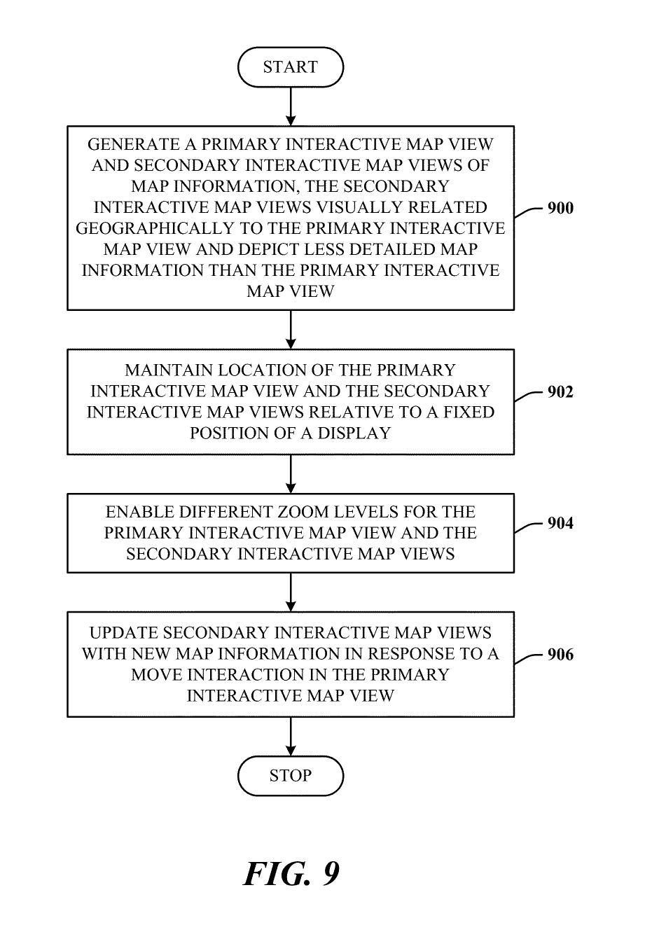

FIG. 9 illustrates an alternative method in accordance with the disclosed architecture. At 900, a primary interactive map view and secondary interactive map views of map information are generated. The secondary interactive map views are visually related geographically to the primary interactive map view and depict less detailed map information than the primary interactive map view. At 902, location of the primary interactive map view and the secondary interactive map views are maintained relative to a fixed position of a display. At 904, different zoom levels are enabled for the primary interactive map view and the secondary interactive map views. At 906, the secondary interactive map views are updated with new map information in response to a move interaction in the primary interactive map view.

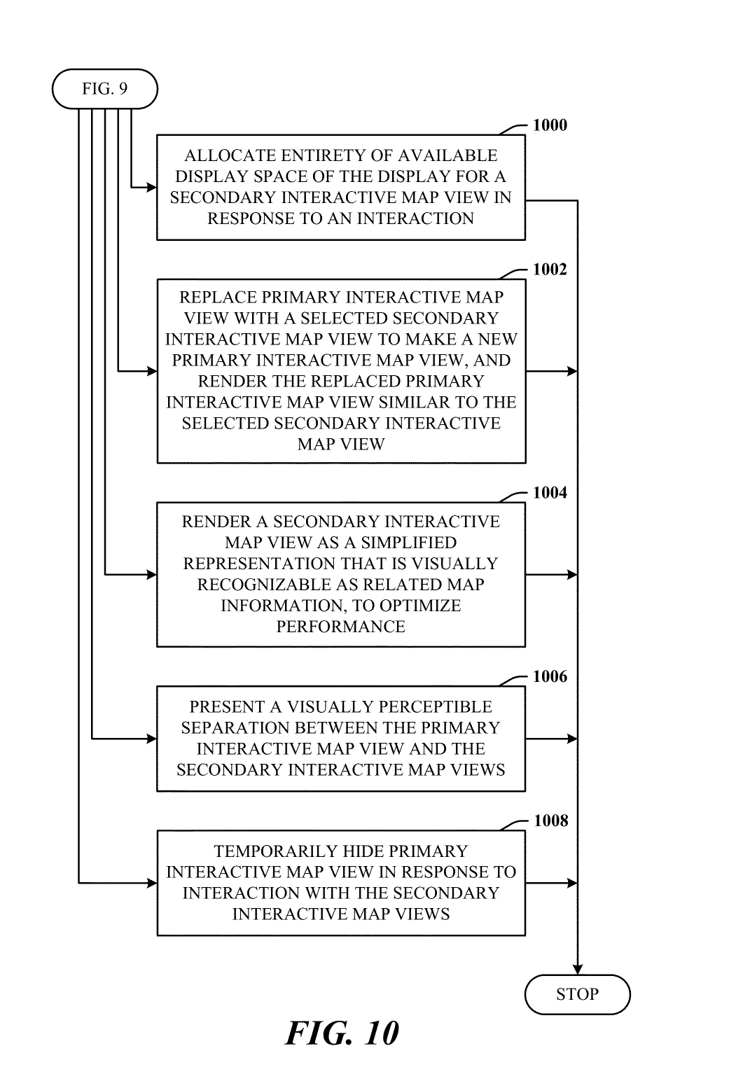

FIG. 10 illustrates further aspects of the method of FIG. 9. Note that the flow indicates that each block can represent a step that can be included, separately or in combination with other blocks, as additional aspects of the method represented by the flow chart of FIG. 9. At 1000, the entirety of the available display space of the display can be allocated for a secondary interactive map view in response to an interaction. At 1002, the primary interactive map view can be replaced with a selected secondary interactive map view to make a new primary interactive map view. The replaced primary interactive map view can be rendered similar to the selected secondary interactive map view. At 1004, a secondary interactive map view is rendered as a simplified representation that is visually recognizable as related map information, to optimize performance. At 1006, a visually perceptible separation is presented between the primary interactive map view and the secondary interactive map views. At 1008, the primary interactive map view is temporarily hidden in response to interaction with the secondary interactive map views.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

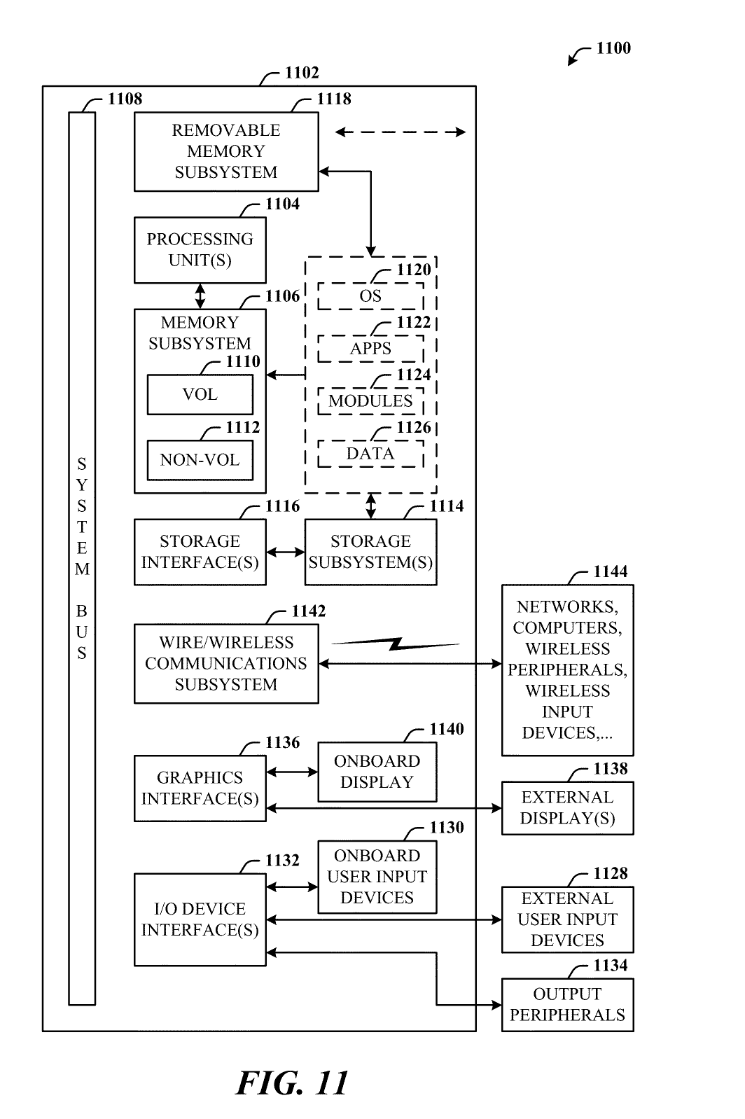

Referring now to FIG. 11, there is illustrated a block diagram of a computing system 1100 that executes interactive navigation and view selection in digital cartography in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. Additionally, the description applies as well to smartphones, and other suitable mobile devices having similar hardware and software capabilities and functionality.

In order to provide additional context for various aspects thereof, FIG. 11 and the following description are intended to provide a brief, general description of the suitable computing system 1100 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1100 for implementing various aspects includes the computer 1102 having processing unit(s) 1104, a computer-readable storage such as a system memory 1106, and a system bus 1108. The processing unit(s) 1104 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1106 can include computer-readable storage (physical storage media) such as a volatile (VOL) memory 1110 (e.g., random access memory (RAM)) and non-volatile memory (NON-VOL) 1112 (e.g., ROM, EPROM, EEPROM, etc.). A basic input/output system (BIOS) can be stored in the non-volatile memory 1112, and includes the basic routines that facilitate the communication of data and signals between components within the computer 1102, such as during startup. The volatile memory 1110 can also include a high-speed RAM such as static RAM for caching data.

The system bus 1108 provides an interface for system components including, but not limited to, the system memory 1106 to the processing unit(s) 1104. The system bus 1108 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1102 further includes machine readable storage subsystem(s) 1114 and storage interface(s) 1116 for interfacing the storage subsystem(s) 1114 to the system bus 1108 and other desired computer components. The storage subsystem(s) 1114 (physical storage media) can include one or more of a hard disk drive (HDD), a magnetic floppy disk drive (FDD), and/or optical disk storage drive (e.g., a CD-ROM drive DVD drive), for example. The storage interface(s) 1116 can include interface technologies such as EIDE, ATA, SATA, and IEEE 1394, for example.

One or more programs and data can be stored in the memory subsystem 1106, a machine readable and removable memory subsystem 1118 (e.g., flash drive form factor technology), and/or the storage subsystem(s) 1114 (e.g., optical, magnetic, solid state), including an operating system 1120, one or more application programs 1122, other program modules 1124, and program data 1126.

The operating system 1120, one or more application programs 1122, other program modules 1124, and/or program data 1126 can include entities and components of the system 100 of FIG. 1, entities and the interface 200 of FIG. 2, entities and the interface 300 of FIG. 3, entities and the interface 400 of FIG. 4, entities and the interface 500 of FIG. 5, and the methods represented by the flowcharts of FIGS. 7-10, for example.

Generally, programs include routines, methods, data structures, other software components, etc., that perform particular tasks or implement particular abstract data types. All or portions of the operating system 1120, applications 1122, modules 1124, and/or data 1126 can also be cached in memory such as the volatile memory 1110, for example. It is to be appreciated that the disclosed architecture can be implemented with various commercially available operating systems or combinations of operating systems (e.g., as virtual machines).

The storage subsystem(s) 1114 and memory subsystems (1106 and 1118) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 1102 and includes volatile and non-volatile internal and/or external media that is removable or non-removable. For the computer 1102, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1102, programs, and data using external user input devices 1128 such as a keyboard and a mouse. Other external user input devices 1128 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1102, programs, and data using onboard user input devices 1130 such a touchpad, microphone, keyboard, etc., where the computer 1102 is a portable computer, for example. These and other input devices are connected to the processing unit(s) 1104 through input/output (I/O) device interface(s) 1132 via the system bus 1108, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 1132 also facilitate the use of output peripherals 1134 such as printers, audio devices, camera devices, and so on, such as a sound card and/or onboard audio processing capability.

The computer 1102 (as well as a mobile device or tablets) can comprise one or more different sensors that can be utilized to support cartography, including, but not limited to, global positioning using satellites or/and cell tower triangulation, digital compass, accelerometer, light sensor, thermometer, barometer, etc.

One or more graphics interface(s) 1136 (also commonly referred to as a graphics processing unit (GPU)) provide graphics and video signals between the computer 1102 and external display(s) 1138 (e.g., LCD, plasma) and/or onboard displays 1140 (e.g., for portable computer). The graphics interface(s) 1136 can also be manufactured as part of the computer system board.

The computer 1102 can operate in a networked environment (e.g., IP-based) using logical connections via a wired/wireless communications subsystem 1142 to one or more networks and/or other computers. The other computers can include workstations, servers, routers, personal computers, microprocessor-based entertainment appliances, peer devices or other common network nodes, and typically include many or all of the elements described relative to the computer 1102. The logical connections can include wired/wireless connectivity to a local area network (LAN), a wide area network (WAN) (e.g., 2G/3G/4G cellular data networks), hotspot, and so on. LAN and WAN networking environments are commonplace in offices and companies and facilitate enterprise-wide computer networks, such as intranets, all of which may connect to a global communications network such as the Internet.

When used in a networking environment the computer 1102 connects to the network via a wired/wireless communication subsystem 1142 (e.g., a network interface adapter, onboard transceiver subsystem, etc.) to communicate with wired/wireless networks, wired/wireless printers, wired/wireless input devices 1144, and so on. The computer 1102 can include a modem or other means for establishing communications over the network. In a networked environment, programs and data relative to the computer 1102 can be stored in the remote memory/storage device, as is associated with a distributed system. It will be appreciated that the network connections shown are exemplary and other means of establishing a communications link between the computers can be used.

The computer 1102 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a mapping component that receives cartographic data for viewing in multiple views on a display;
a view component that presents the cartographic data in an interactive secondary view and a primary portion of the cartographic data in an interactive primary view, the primary and secondary views are located relative to a fixed position of a display; and
a processor that executes computer-executable instructions associated with at least one of the mapping component or the view component.

2. The system of claim 1, wherein the locations of the primary view and the secondary view are maintained relative to the fixed position.

3. The system of claim 1, wherein the location of the fixed position and the location of the primary view and the secondary view relative to the fixed position, are constantly maintained during updates in the cartographic data in response to interactive changes in the cartographic data as viewed.

4. The system of claim 1, wherein the primary view is temporarily hidden in response to interaction with the secondary view.

5. The system of claim 1, wherein the secondary view consumes available space of the display in response to interaction with the secondary view.

6. The system of claim 1, wherein the primary view is an enlarged view of the primary portion of the cartographic data of the secondary view.

7. The system of claim 1, wherein the interaction with a given portion of the cartographic data in the secondary view promotes the given portion of the cartographic data to the primary view.

8. The system of claim 1, wherein the view component changes the cartographic data in the primary view in response to an interactive change in the cartographic data in the secondary view, and changes the cartographic data in the secondary view in response to an interactive change in the cartographic data in the primary view.

9. A method, comprising acts of:
generating a primary interactive view and a secondary interactive view of cartographic data, the secondary interactive view related geographically to the primary interactive view and depicts less detailed map information than the primary interactive view;
maintaining alignment of the primary interactive view and the secondary interactive view relative to a fixed position of a display;
processing interactions with the primary interactive view and secondary interactive view to change presentation of the cartographic data according to the interactions; and
utilizing a processor that executes instructions stored in memory to perform at least one of the acts of generating, maintaining, or processing.

10. The method of claim 9, further comprising temporarily hiding the primary interactive view in response to interaction with the secondary interactive view.

11. The method of claim 9, further comprising replacing the primary interactive view with the secondary interactive view based on interaction with the secondary interactive view.

12. The method of claim 9, further comprising generating additional secondary interactive views of corresponding portions of the cartographic data, and replicating an interactive move operation on the primary interactive view to all secondary interactive views to track movement in the primary interactive view.

13. The method of claim 9, further comprising presenting the secondary interactive view in an entire map display area of the display in response to interaction with the secondary interactive view.

14. The method of claim 9, further comprising enabling different zoom levels for the primary interactive view and the secondary interactive view.

15. A method, comprising acts of:
generating a primary interactive map view and secondary interactive map views of map information, the secondary interactive map views visually related geographically to the primary interactive map view and depict less detailed map information than the primary interactive map view;
maintaining location of the primary interactive map view and the secondary interactive map views relative to a fixed position of a display;
enabling different zoom levels for the primary interactive map view and the secondary interactive map views;
updating the secondary interactive map views with new map information in response to a move interaction in the primary interactive map view; and
utilizing a processor that executes instructions stored in memory to perform at least one of the acts of generating, maintaining, enabling, or updating.

16. The method of claim 15, further comprising allocating entirety of available display space of the display for a secondary interactive map view in response to an interaction.

17. The method of claim 15, further comprising replacing the primary interactive map view with a selected secondary interactive map view to make a new primary interactive map view, and rendering the replaced primary interactive map view similar to the selected secondary interactive map view.

18. The method of claim 15, further comprising rendering a secondary interactive map view as a simplified representation that is visually recognizable as related map information, to optimize performance.

19. The method of claim 15, further comprising presenting a visually perceptible separation between the primary interactive map view and the secondary interactive map views.

20. The method of claim 15, further comprising temporarily hiding the primary interactive map view in response to interaction with the secondary interactive map views.
